(19) United States
(12) Patent Application Publication
(10) Pub. No.: US 2003/0170400 A1
(43) Pub. Date: Sep. 11, 2003

(54) Low chroma, dark photo-curable compositions

(76) Inventors: Hugh Stephen Laver, Reinach (CH); Jules Lahave, Lanaken (BE); Conny Te Walvaart, De Bunde (NL)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/380,028

(22) PCT Filed: Oct. 9, 2001
(86) PCT No.: PCT/EP01/11646

(30) Foreign Application Priority Data
Oct. 18, 2000 (EP) 008109605

(51) Int. Cl. B05D 1/04

(52) U.S. Cl. 427/458; 522/71; 522/75

(57) ABSTRACT

The invention provides a photo-curable composition for manufacturing thick layers of homogeneous grey to black colour with excellent physical properties as required for use in high tech applications such as for example powder coatings. Such compositions were highly desirable but yet unachieved in the art. The instant composition comprises a radiation curable material as well as both an iron oxide and a phthalocyanine pigment. It has a lightness (L*) of from 0 to 90 and a chroma (C*) of from 0 to 30. The process of hardening said composition by irradiation with light of the wavelength from 150 to 600 nm is also claimed.

The invention provides a photo-curable composition for manufacturing thick layers of homogeneous grey to black colour with excellent physical properties as required for use in high tech applications such as for example powder coatings. Such compositions were highly desirable but yet unachieved in the art.

DD-301810 A7. discloses brown olive pigment compositions comprising Pigment Green 17, Pigment Blue 17, Pigment Red 101, Pigment Yellow 42 and Pigment White 6 (all references to the Colour Index). There is no mention nor suggestion of any possible use in UV-curing compositions.

Pigmented compositions are known in the art to be quite difficult to cure by UV light. This is especially true for compositions comprising iron oxides, for which farbe+lack 104(12), 81-85 [1998] suggests to use a better photoinitiator (bisacylphosphinoxide) together with pigments of low surface area. However, curing layers containing iron oxide pigments still remains difficult and leads to not entirely satisfying pendulum hardness as is also disclosed in farbe+lack 104(2), 42-49 [1998].

Alternatively, farbe+lack 100(11), 923-929 [1994] discloses to reduce the amount of carbon black to 0.5%, while combining it with barium sulfate or calcium carbonate fillers.

Journal of Coatings Technology Vol. 71 No. 891, 37-44 [1999] also emphasize the role of the photoinitiator, while disclosing that carbon black and organic red or blue pigments exhibit a satisfactory curing performance even at considerable hiding power, while yellow and red iron oxides lead to wrinkle formation as the result of an unbalanced crosslinking process.

U.S. Pat. No. 6,026,207 discloses an UV-curable layer of black appearing colour coating for optical fibers, comprising each a red, blue and yellow organic pigment. No structure is given.

An entirely different approach is the use of better reactive curing compositions or curing systems of higher efficiency, such as disclosed for example in U.S. Pat. No. 5,536,758 wherein a composition based on an aromatic urethane acrylic and isobornyl acrylate monomers is cured first at 425 nm, then at 375 nm.

The prior art compositions as mentioned above do not satisfy all requirements in the art. In particular, it is still difficult to get satisfactory results upon hardening. The maximum amount of pigment and layer thickness are lower than desirable, and sometimes it is necessary to upgrade or replace the available equipment. Moreover, one cannot use the same compositions for all colours but must optimize them separately for each colour.

Surprisingly, a significant improvement of UV-curing compositions for grey to slate or black shades could now be achieved through the simultaneous use of both an iron oxide and a phthalocyanine pigment. The phthalocyanine has an entirely unexpected, synergistic effect on the hardening of UV-curing compositions comprising iron oxides. Another advantage of the instant compositions is that, once cured, they absorb less infrared radiation than prior art compositions having the same colour in the CIE-L*a*b* colour space. Thus, the comfort and life-time of outdoor coatings (i.e. for automotive or metallic building parts) are improved.

Thus, the invention pertains to a composition having a lightness (L*) of from 0 to 90 and a chroma (C*) of from 0 to 30, comprising a radiation curable material, iron oxide and a phthalocyanine pigment.

The iron oxide is preferably a synthetic red iron oxide containing at least 93% by weight of ferric oxide and conforming to ASTM D3721-83, such as Pigment Red 101. The phthalocyanine pigment is preferably a copper phthalocyanine pigment, especially an unsubstituted blue phthalocyanine pigment, most preferably an unsubstituted β copper phthalocyanine such as Pigment Blue 15:3 or Pigment Blue 15:4. The amount of iron oxide is suitably from 0.1 to 50% by weight, preferably from 0.5 to 20% by weight, based on the radiation curable material. The iron oxide's specific surface area is preferably from 1 to 6 m²/g. Most preferred, the iron oxide should have a relatively bluish shade, such that a hiding coating thereof gives a hue angle (h) of 32 or less (towards 0). The amount of phthalocyanine is suitably from 0.001 to 30% by weight, preferably from 0.01 to 10% by weight, based on the radiation curable material. The phthalocyanine's specific surface area is preferably from 30 to 120 m²/g, most preferably from 40 to 80 m²/g. The weight ratio of iron oxide to phthalocyanine is preferably from 5:1 to 125:1, especially from 10:1 to 75:1, most preferred from 15:1 to 50:1, very especially from 20:1 to 30:1.

Preferably, the iron oxide and the phthalocyanine pigment are first intimately mixed in the above-mentioned ratio, optionally together with other colorants, leading to a pigment composition which is most preferably predispersed in a carrier resin, which must not necessarily be curable by radiation. Methods for intimately mixing pigments and for dispersing them in a carrier resin are well-known in the art.

Thus, the invention also pertains to a pigment composition comprising homogeneously mixed iron oxide and phthalocyanine pigment in a weight ratio of from 5:1 to 125:1, especially from 10:1 to 75:1, most preferred from 15:1 to 50:1, very especially from 20:1 to 30:1.

The invention also pertains to such a composition additionally comprising a carrier resin in which the iron oxide and the phthalocyanine pigment are dispersed.

The colour of the instant composition is most suitably determined by applying it on a flat substrate in an amount sufficient to hide entirely the substrate, then hardening by irradiation and measuring its reflection colour with a spectrophotometer (CIE 1976 L*a*b* colour space) after hardening is completed. The lightness (L*) is preferably from 0 to 85, most preferably from 0 to 80. The chroma (C*) is preferably from 0 to 20, more preferably from 0 to 10, most preferably from 0 to 5.

The instant compositions are preferably in powder form.

The instant compositions can optionally also comprise customary additives, as well as further inorganic, organic or metallic pigments in usual amounts (including effect pigments such as based on aluminium flakes, mica or multilayer systems). Amongst the additives which can be used, there are especially photoinitiators such as those usual in the art (see below). It is also possible to add for example IR-absorbers. When further pigments are used, then white and/or black ones are preferred to such of other colours. Preferably, the instant compositions also comprise titanium dioxide, carbon black or a mixture thereof. Black pigments such as carbon black—if any—are preferably added in an amount of from 0.01 to 2 parts, most preferred from 0.1 to 1 part, based on the weight of the phthalocyanine. White pigments such as rutile—if any—are preferably added in an amount of from 1 to 1000 parts, most preferred from 50 to 500 parts, based on the weight of the phthalocyanine. However, the total amount of pigments including iron oxide and phthalocyanine should not go beyond about 60% by weight, preferably not beyond 30% by weight, based on the radiation curable material. It is also possible to use further coloured pigments in the instant composition in order to shade and/or optimize the color values of the black color to be obtained.

Powder coatings can be based on solid resins and monomers containing reactive double bonds, for example maleates, vinyl ethers, acrylates, acrylamides and mixtures thereof. A free-radically UV-curable powder coating can be formulated by mixing unsaturated polyester resins with solid acrylamides (for example methyl methylacrylamidoglycolate) and a free-radical photoinitiator, such formulations being as described, for example, by M. Wittig and Th. Gohmann in “Radiation Curing of Powder Coating”, Conference Proceedings, Radtech Europe 1993. Free-radically UV-curable powder coatings can also be formulated by mixing unsaturated polyester resins with solid acrylates, methacrylates or vinyl ethers and with a photoinitiator (or mixture of photoinitiators). The powder coatings may also comprise binders as are described, for example, in DE-A-42 28 514 and in EP-A-636 669. The procedure normally comprises electrostatic or tribostatic spraying of the powder onto the substrate, for example metal or wood, melting of the powder by heating, and, after a smooth film has formed, radiation-curing of the coating with ultraviolet and/or visible light, using, for example, medium-pressure mercury lamps, metal halide lamps or xenon lamps. A particular advantage of the radiation-curable powder coatings over their heat-curable counterparts is that the flow time after melting of the powder particles can be extended if desired in order to ensure the formation of a smooth, high- or low-gloss coating. In contrast to heat-curable systems, radiation-curable powder coatings can be formulated to melt at lower temperatures without the unwanted effect of shortening their storage stability. For this reason, they are also suitable as coatings for heat-sensitive substrates, for example wood or plastics.

Preferred are powder coating compositions in which the unsaturated monomer or binder is a polyester, polyurethane, polyacrylate, an acrylate or methacylate-functionalised epoxy resin or an unsaturated carboxylic acid ester of an hydroxyalkylamide. One or more vinyl ester or vinyl ether compounds may further be added.

In addition to photoinitiators, the powder coating formulations may also include UV absorbers or other additives. Appropriate examples are listed below.

A convenient process for applying a powder coating composition on a substrate comprises:

i) electrostatic application of the powder composition;

ii) application of heat to melt and fuse the powder; then

iii) electromagnetic irradiation of the coating.

The source of electromagnetic irradiation is preferably a medium pressure mercury lamp or a metal-doped mercury lamp

However, the instant composition is not at all required to be in powder form. It can for example be based on unsaturated compounds including one or more olefinic double bonds. They may be of low (monomeric) or high (oligomeric) molecular mass. Examples of monomers containing a double bond are alkyl or hydroxyalkyl acrylates or methacrylates, for example methyl, ethyl, butyl, 2-ethylhexyl or 2-hydroxyethyl acrylate, isobornyl acrylate, methyl methacrylate or ethyl methacrylate. Interesting also are resins which are modified with silicon or fluor, e.g. silicon acrylates. Other examples are acrylonitrile, acrylamide, methacrylamide, N-substituted (meth)acrylamides, vinyl esters such as vinyl acetate, vinyl ethers such as isobutyl vinyl ether, styrene, alkyl- and halostyrenes, N-vinylpyrrolidone, vinyl chloride or vinylidene chloride.

Examples of monomers containing two or more double bonds are the diacrylates of ethylene glycol, propylene glycol, neopentyl glycol, hexamethylene glycol or of bisphenol A, and 4,4′-bis(2-acryl-oyloxyethoxy)diphenylpropane, trimethylolpropane triacrylate, pentaerythritol triacrylate or tetraacrylate, vinyl acrylate, divinylbenzene, divinyl succinate, diallyl phthalate, triallyl phosphate, triallyl isocyanurate or tris(2-acryloylethyl) isocyanurate.

Examples of polyunsaturated compounds of relatively high molecular mass (oligomers) are acrylisized epoxy resins, acrylisized polyesters, polyesters containing vinyl ether or epoxy groups, and also polyurethanes and polyethers. Further examples of unsaturated oligomers are unsaturated polyester resins, which are usually prepared from maleic acid, phthalic acid and one or more diols and have molecular weights of from about 500 to 3000. In addition it is also possible to employ vinyl ether monomers and oligomers, and also maleate-terminated oligomers with polyester, polyurethane, polyether, polyvinyl ether and epoxy main chains. Of particular suitability are combinations of oligomers which carry vinyl ether groups and of polymers as described in WO 90/01512. However, copolymers of vinyl ether and maleic acid-functionalized monomers are also suitable. Unsaturated oligomers of this kind can also be referred to as prepolymers.

Particularly suitable examples are esters of ethylenically unsaturated carboxylic acids and polyols or polyepoxides, and polymers having ethylenically unsaturated groups in the chain or in side groups, for example unsaturated polyesters, polyamides and polyurethanes and copolymers thereof, alkyd resins, polybutadiene and butadiene copolymers, polyisoprene and isoprene copolymers, polymers and copolymers containing (meth)acrylic groups in side chains, and also mixtures of one or more such polymers.

Examples of unsaturated carboxylic acids are acrylic acid, methacrylic acid, crotonic acid, itaconic acid, cinnamic acid, and unsaturated fatty acids such as linolenic acid or oleic acid. Acrylic and methacrylic acid are preferred.

Suitable polyols are aromatic and, in particular, aliphatic and cycloaliphatic polyols. Examples of aromatic polyols are hydroquinone, 4,4′-dihydroxydiphenyl, 2,2-di(4-hydroxyphenyl)propane, and also novolaks and resols. Examples of polyepoxides are those based on the abovementioned polyols, especially the aromatic polyols, and epichlorohydrin. Other suitable polyols are polymers and copolymers containing hydroxyl groups in the polymer chain or in side groups, examples being polyvinyl alcohol and copolymers thereof or polyhydroxyalkyl methacrylates or copolymers thereof. Further polyols which are suitable are oligoesters having hydroxyl end groups.

Examples of aliphatic and cycloaliphatic polyols are alkylenediols having preferably 2 to 12 C atoms, such as ethylene glycol, 1,2- or 1,3-propanediol, 1,2-, 1,3- or 1,4-butanediol, pentanediol, hexanediol, octanediol, dodecanediol, diethylene glycol, triethylene glcyol, polyethylene glycols having molecular weights of preferably from 200 to 1500, 1,3-cyclopentanediol, 1,2-, 1,3- or 1,4-cyclohexanediol, 1,4-dihydroxymethylcyclohexane, glycerol, tris(β-hydroxyethyl)amine, trimethylolethane, trimethylolpropane, pentaerythritol, dipentaerythritol and sorbitol.

The polyols may be partially or completely esterified with one carboxylic acid or with different unsaturated carboxylic acids, and in partial esters the free hydroxyl groups may be modified, for example etherified or esterified with other carboxylic acids. Examples of esters are trimethylolpropane triacrylate, trimethylolethane triacrylate, trimethylolpropane trimeth-acrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol tris-itaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetra methacrylate, sorbitol pentaacrylate, sorbitol hexaacrylate, oligoester acrylates and methacrylates, glycerol diacrylate and triacrylate, 1,4-cyclohexane diacrylate, bisacrylates and bismethacrylates of polyethylene glycol with a molecular weight of from 200 to 1500, or mixtures thereof.

Also suitable as components of the instant compositions are the amides of identical or different, unsaturated carboxylic acids with aromatic, cycloaliphatic and aliphatic polyamines having preferably 2 to 6, especially 2 to 4, amino groups. Examples thereof are ethylenediamine, 1,2- or 1,3-propylenediamine, 1,2-, 1,3- or 1,4-butylenediamine, 1,5-pentylenediamine, 1,6-hexylenediamine, octylenediamine, dodecylenediamine, 1,4-diaminocyclohexane, isophoronediamine, phenylenediamine, bisphenylenediamine, di-β-aminoethyl ether, diethylenetriamine, triethylenetetramine, di(β-aminoethoxy)- or di(β-aminopropoxy)ethane. Other suitable polyamines are polymers and copolymers, preferably with additional amino groups in the side chain, and oligoamides having amino end groups. Examples of such unsaturated amides are methylenebisacrylamide, 1,6-hexamethylenebisacrylamide, diethylenetriaminetrismethacrylamide, bis(methacrylamidopropoxy)ethane, β-methacrylamidoethyl methacrylate and N[(β-hydroxyethoxy)ethyl]acrylamide.

Suitable unsaturated polyesters and polyamides are derived, for example, from maleic acid and from diols or diamines. Some of the maleic acid can be replaced by other dicarboxylic acids. They can be used together with ethylenically unsaturated comonomers, for example styrene. The polyesters and polyamides may also be derived from dicarboxylic acids and from ethylenically unsaturated diols or diamines, especially from those with relatively long chains of, for example 6 to 20 C atoms. Examples of polyurethanes are those composed of saturated or unsaturated diisocyanates and of unsaturated or, respectively, saturated diols.

Polybutadiene and polyisoprene and copolymers thereof are known. Examples of suitable comonomers are olefins, such as ethylene, propene, butene and hexene, (meth)acrylates, acrylonitrile, styrene or vinyl chloride. Polymers with (meth)acrylate groups in the side chain are likewise known. They may, for example, be reaction products of epoxy resins based on novolaks with (meth)acrylic acid, or may be homo- or copolymers of vinyl alcohol or hydroxyalkyl derivatives thereof which are esterified with (meth)acrylic acid, or may be homo- and copolymers of (meth)acrylates which are esterified with hydroxyalkyl (meth)acrylates, with a special mention of mixtures of polyol (meth)acrylates.

Binders as well can be added to these novel compositions, and this is particularly expedient when the photopolymerizable compounds are liquid or viscous substances. The quantity of binder may, for example, be 5-95%, preferably 10-90% and especially 40-90%, by weight relative to the overall solids content. The choice of binder is made depending on the field of application and on properties required for this field, such as the capacity for development in aqueous and organic solvent systems, adhesion to substrates and sensitivity to oxygen.

Examples of suitable binders are polymers having a molecular weight of about 5,000 to 2,000,000, preferably 10,000 to 1,000,000. Examples are homo- and copolymers of acrylates and methacrylates, for example copolymers of methyl methacrylate/ethyl acrylate/methacrylic acid, poly(alkyl methacrylates), poly(alkyl acrylates); cellulose esters and cellulose ethers, such as cellulose acetate, cellulose acetobutyrate, methylcellulose, ethylcellulose; polyvinylbutyral, polyvinylformal, cyclized rubber, polyethers such as polyethylene oxide, polypropylene oxide and polytetrahydrofuran; polystyrene, polycarbonate, polyurethane, chlorinated polyolefins, polyvinyl chloride, vinyl chloridelvinylidene copolymers, copolymers of vinylidene chloride with acrylonitrile, methyl methacrylate and vinyl acetate, polyvinyl acetate, copoly(ethylenelvinyl acetate), polymers such as polycaprolactam and poly-(hexamethylenadipamide), and polyesters such as poly(ethylene glycol terephtalate) and poly(hexamethylene glycol succinate) and polyimides.

Carrier resins are well-known in the art of pigment concentrates and masterbatches and can be for example be binders as mentioned above, but preferably binders based on urea and keto aldehyde, acrylic or polyester resins, or also waxes. They should suitably be chosen so as to be compatible with the radiation curable materials. In principle, any compatible carrier resin can be used. Particular reference is made to the resins and binders disclosed in EP-A-0 432 480 and EP-A-1 026 212.

The unsaturated compounds can also be used as a mixture with non-photopolymerizable, film-forming components. These may, for example, be physically drying polymers or solutions thereof in organic solvents, for instance nitrocellulose or cellulose acetobutyrate. They may also, however, be chemically and/or thermally curable (heat-curable) resins, examples being polyisocyanates, polyepoxides and melamine resins, as well as polyimide precursors. The use of heat-curable resins at the same time is important for use in systems known as hybrid systems, which in a first stage are photopolymerized and in a second stage are crosslinked by means of thermal aftertreatment.

In addition to the photoinitiator, the photopolymerizable mixtures may include various additives. Examples of these are thermal inhibitors, which are intended to prevent premature polymerization, examples being hydroquinone, hydroquinine derivatives, p-methoxyphenol, β-naphthol or sterically hindered phenols, such as 2,6-di-tert-butyl-p-cresol. In order to increase the stability on storage in the dark it is possible, for example, to use copper compounds, such as copper naphthenate, stearate or octoate, phosphorus compounds, for example triphenylphosphine, tributylphosphine, triethyl phosphite, triphenyl phosphite or tribenzyl phosphite, quaternary ammonium compounds, for example tetramethylammonium chloride or trimethylbenzylammonium chloride, or hydroxylamine derivatives, for example N-diethylhydroxylamine. To exclude atmospheric oxygen during the polymerization it is possible to add paraffin or similar wax-like substances which, being of inadequate solubility in the polymer, migrate to the surface in the beginning of polymerization and form a transparent surface layer which prevents the ingress of air. It is also possible to apply an oxygen-impermeable layer. Light stabilizers which can be added in a small quantity are UV absorbers, for example those of the hydroxyphenylbenzotriazole, hydroxyphenyl-benzophenone, oxalamide or particularly hydroxyphenyl-s-triazine type. These compounds can be used individually or in mixtures, with or without sterically hindered amines (HALS).

Examples of UV absorbers and light stabilizers are 2-(2′-hydroxyphenyl)benzotriazoles, for example 2-(2′-hydroxy-5′-methylphenyl)benzotriazole, 2-(3′,5′-di-tert-butyl-2′-hydroxyphenyl)benzotriazole or analogues, 2-hydroxybenzophenones, esters of substituted or unsubstituted benzoicacids, for example 4-tert-butylphenyl salicylate, dibenzoylresorcinol or 2,4-di-tert-butylphenyl 3,5-di-tert-butyl-4-hydroxybenzoate, acrylates, for example isooctyl α-cyano-β,β-diphenyl acrylate, methyl α-carbomethoxycinnamate, or N-(β-carbomethoxy-β-cyanovinyl)-2-methylindoline, sterically hindered amines, for example bis-(2,2,6,6-tetramethylpiperidyl) sebacate or succinate, 4-benzoyl-2,2,6,6-tetramethylpiperidine, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione and analogues, oxalamides, for example 4,4′-dioctyloxyoxanilide, N,N′-bis-(3-dimethylaminopropyl)oxalamide and analogues, 2-(2-hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis-(2,4-dimethylphenyl)-1,3,5-triazine or 2,4-bis(2-hydroxy-4-propyloxy-phenyl)-6-(2,4-dimethylphenyl)-1,3,5-triazine and analogues, phosphites and phosphonites, for example triphenyl phosphite, tris-(2,4-di-tert-butylphenyl) phosphite, diisodecyl pentaerythrityl diphosphite, tristearyl sorbityl triphosphite, tetrakis-(2,4-di-tert-butylphenyl)-4,4′-biphenylene diphosphonite, 6-isooctyloxy-2,4,8,10-tetra-tert-butyl-12H-dibenzo[d,g]-1,3,2-dioxaphosphocine or bis-(2,4-di-tert-butyl-6-methylphenyl) methyl phosphite and analogues.

Further examples are “Krypto-UVA” as for example described in EP-A-180548 or latent UVA, as for example disclosed by Hida et al. in RadTech Asia 97, 212 (1997) can be used.

Further additives known in the art may also be added, as for example corrosion inhibitors, antistatics, matting agents, tribocharging agents, degassers or waxes, flow improvers and adhesion promoters.

To accelerate the photopolymerization it is possible to add amines, for example triethanolamine, N-methyidiethanolamine, p-dimethylaminobenzoate or Michler's ketone. The action of the amines can be intensified by the addition of aromatic ketones of the benzophenone type. Examples of amines which can be used as oxygen scavengers are substituted N,N-dialkyl-anilines, as are described in EP-A-339841. Other accelerators, coinitiators and autoxidizers are thiols, thioethers, disulfides, phosphonium salts, phosphine oxides or phosphines, as described, for example, in EP-A-438123, in GB-2,180,358 and in JP-A-06/68309.

It is further possible to add chain transfer agents which are customary in the art to the compositions according to the invention. Examples are mercaptanes, amines and benzothiazol.

Photopolymerization can also be accelerated by adding further photosentisizers which shift or broaden the spectral sensitivity. These are, in particular, aromatic carbonyl compounds, for example benzophenone, thioxanthone, anthraquinone and 3-acylcoumarin derivatives, and also 3-(aroylmethylene)thiazolines, camphor quinone, but also eosine, rhodamine and erythrosine dyes, as well as all compounds which can be used as coinitiators as described above.

Further specific examples of such photosensitizers well-known in the art are carbonyl compounds such as thioxanthones, benzophenones, 3-acyl coumarins, 3-(aroylmethylene)-thiazolines, acetophenones, benzil, 2-acetylnaphthalene, 2-naphthaldehyde, 9,10-anthraquinone, 9-fluorenone, dibenzosuberone, xanthone, 2,5-bis(4-diethylaminobenzylidene)cyclopentanone, α-(para-dimethylaminobenzylidene)ketones such as 2-(4-dimethylaminobenzylidene)-indan-1-one or 3-(4-dimethylamino-phenyl)-1-indan-5-yl-propenone, phthalimides or benzoates such as poly(propyleneglycol)-4-(dimethylamino) benzoate.

The curing process can be assisted by, in particular, compositions which are pigmented (for example with titanium dioxide), and also by adding a component which under thermal conditions forms free radicals, for example an azo compound such as 2,2′-azobis(4-methoxy-2,4-dimethylvaleronitrile), a triazene, diazo sulfide, pentazadiene or a peroxy compound, for instance a hydroperoxide or peroxycarbonate, for example t-butyl hydroperoxide, as described for example in EP-A-245639.

The compositions according to the invention may comprise as further additive a photoreducable dye, e.g., xanthene-, benzoxanthene-, benzothioxanthene, thiazine-, pyronine-, porphyrine- or acridine dyes, and/or trihalogenmethyl compounds which can be cleaved by irradiation. Similar compositions are for example described in EP-A-445624.

Further customary additives, depending on the intended use, are optical brighteners, fillers, pigments, dyes, wetting agents or levelling assistants. In order to cure thick and pigmented coatings it is appropriate to add glass microspheres or pulverized glass fibres, as described for example in U.S. Pat. No. 5,013,768.

Depending on the kind of application, the instant compositions may also comprise further colorants known to the person skilled in the art, such as organic as well as anorganic pigments as disclosed above, or also dyes. Examples of inorganic pigments are titan dioxide, e.g. of the rutile type or anatas type, carbon black, zinc oxide, such as zink white, iron oxide of different colour, chromium yellow, chromium green, nickel titanium yellow, ultramarine blue, cobalt blue, bismuth vanadate, cadmium yellow or cadmium red. Examples of organic pigments are mono- or bisazo pigments including benzimidazolones, as well as metal complexes or lakes thereof, quinophthalones, phthalocyanines, perylenes, perinones, anthrapyrimidines, flavanthrones, pyranthrones, anthantrones, anthraquinones, thioindigos, quinacridones, diketo-[3,4-c]-pyrrolopyroles, isoindolinones, isoindolines, dioxazines and triarylcarbonium salts. Examples of organic dyes are azo dyes, methin dyes, anthraquinone dyes or metal complex dyes. The skilled artisan knows how to choose the further pigments as well as the amount thereof suitable for shifting the hue of the instant compositions to the desired value. Customary concentrations are for example 0.1-20%, in particular 1-5% by weight, based on the whole formulation.

The choice of additive is made depending on the field of application and on properties required for this field. The additives described above are customary in the art and accordingly are added in amounts which are usual in the respective application.

The invention is also suitable for compositions comprising as a component an ethylenically unsaturated photopolymerizable compound which is emulsified or dissolved in water.

Many variants of such radiation-curable aqueous prepolymer dispersions are commercially available. A prepolymer dispersion is understood as being a dispersion of water and at least one prepolymer dispersed therein. The concentration of water in these systems is, for example, from 2 to 80% by weight, in particular from 30 to 60% by weight. The concentration of the radiation-curable prepolymer or prepolymer mixture is, for example, from 95 to 20% by weight, in particular from 70 to 40% by weight. In these compositions, the sum of the percentages given for water and prepolymer is in each case 100, with auxiliaries and additives being added in varying quantities depending on the intended use.

The radiation-curable, film-forming prepolymers which are dispersed in water and are often also dissolved are aqueous prepolymer dispersions of mono- or polyfunctional, ethylenically unsaturated prepolymers which are known per se, can be initiated by free radicals and have for example a content of from 0.01 to 1.0 mol of polymerizable double bonds per 100 g of prepolymer and an average molecular weight of, for example, at least 400, in particular from 500 to 10,000. Prepolymers with higher molecular weights, however, may also be considered depending on the intended application. Use is made, for example, of polyesters containing polymerizable C—C double bonds and having an acid number of not more than 10, of polyethers containing polymerizable C—C double bonds, of hydroxyl-containing reaction products of a polyepoxide, containing at least two epoxide groups per molecule, with at least one α,β-ethylenically unsaturated carboxylic acid, of polyurethane (meth)acrylates and of acrylic copolymers which contain α,β-ethylenically unsaturated acrylic radicals, as are described in EP-A-012339. Mixtures of these prepolymers can likewise be used. Also suitable are the polymerizable prepolymers described in EP-A-033896, which are thioether adducts of polymerizable prepolymers having an average molecular weight of at least 600, a carboxyl group content of from 0.2 to 15% and a content of from 0.01 to 0.8 mol of polymerizable C—C double bonds per 100 g of prepolymer. Other suitable aqueous dispersions, based on specific alkyl (meth)acrylate polymers, are described in EP-A-041125, and suitable waterdispersible, radiation-curable prepolymers of urethane acrylates can be found in DE-A-29 36 039.

Further additives which may be included in these radiation-curable aqueous prepolymer dispersions are dispersion auxiliaries, emulsifiers, antioxidants, light stabilizers, fillers, reaction accelerators, levelling agents, lubricants, wetting agents, thickeners, flatting agents, antifoams and other auxiliaries customary in paint technology. Suitable dispersion auxiliaries are water-soluble organic compounds which are of high molecular mass and contain polar groups, examples being polyvinyl alcohols, polyvinylpyrrolidone or cellulose ethers. Nonionic emulsifiers and, if desired, ionic emulsifiers can be used as well. Photoinitiators are for example camphor quinone, benzophenone or derivatives thereof, many of which are known in the art, [4-(4-methylphenylthio)phenyl]-phenylmethanone, methyl-2-benzoylbenzoate, acetophenone or derivatives thereof, for example α-hydroxy-cycloalkyl phenyl ketones, 2-hydroxy-2-methyl-l-phenyl-propanone, (4-methylthiobenzoyl)-1-methyl-1-morpholinoethane or (4-morpholinobenzoyl)-1-benzyl-1-dimethylaminopropane, 4-aroyl-1,3-dioxolanes, benzoin alkyl ethers, benzil ketals, phenylglyoxalic esters and derivatives thereof, dimeric phenylglyoxalic esters, peresters, e.g. benzophenone tetra-carboxylic peresters as described for example in EP-A-126541, monoacyl phosphine oxides, e.g. (2,4,6-trimethylbenzoyl)diphenylphosphine oxide, bisacylphosphine oxides, bis(2,6-dimethoxy-benzoyl)-(2,4,4-trimethyl-pentyl)phosphine oxide, bis(2,4,6-trimethylbenzoyl)-phenylphosphine oxide, bis(2,4,6-trimethylbenzoyl)-2,4-dipentoxyphenylphosphine oxide, trisacylphosphine oxides, halomethyltriazines, e.g. 2-[2-(4-methoxy-phenyl)-vinyl]-4,6-bis-trichloromethyl-[1,3,5]triazine, 2-(4-methoxy-phenyl)4,6-bis-trichloromethyl-[1,3,5]triazine, 2-(3,4-dimethoxy-phenyl)-4,6-bis-trichloromethyl-[1,3,5]triazine or 2-methyl-4,6-bis-trichloromethyl-[1,3,5]triazine, hexaarylbisimidazole/coinitiators systems, e.g. ortho-chlorohexaphenyl-bisimidazole combined with 2-mercaptobenzthiazole, ferrocenium compounds, or titanocenes, e.g. bis(cyclopentadienyl)-bis(2,6-difluoro-3-pyrryl-phenyl)titanium. Further, borate compounds can be used as coinitiators.

Where the photoinitiator systems are employed in hybrid systems, use is made, in addition to the free-radical hardeners, of cationic photoinitiators, for example peroxide compounds, such as benzoyl peroxide (other suitable peroxides are described in U.S. Pat. No. 4,950,581 column 19, lines 17-25), aromatic sulfonium-, phosphonium- or iodonium salts as described for example in U.S. Pat. No. 4,950,581, column 18, line 60 to column 19, line 10 or cyclopentadienylarene-iron(II) complex salts, for example (η⁶-iso-propylbenzene)(η⁵-cyclopentadienyl)iron(II) hexafluorophosphate.

Of course, it is also possible to use cationic photoinitiators alone in the instant compositions.

The photopolymerizable compositions generally comprise from 0.05 to 15% by weight, preferably from 0.1 to 10% by weight, most preferred from 0.2 to 5% by weight, of the photoinitiator or mixture thereof, based on the composition. Preferred photoinitiators are mono- or bis-acylphosphine oxide photoinitiators, most preferably in combination with an α-hydroxy ketone or a benzyl diketal photoinitiator.

The photopolymerizable compositions can be used for various purposes, for example as printing ink, e.g. as screen printing ink, ink for flexoprinting or offsetprinting, as a clear finish, as a coloured finish, as a white finish, for example for wood or metal, as powder coating, as a coating material, inter alia for paper, wood, metal or plastic, as a daylight-curable coating for the marking of buildings and roadmarking, for photographic reproduction techniques, for holographic recording materials, for image recording techniques or to produce printing plates which can be developed with organic solvents or with aqueous alkalis, for producing masks for screen printing, as dental filling compositions, as adhesives, as pressure-sensitive adhesives, as laminating resins, as photoresits, e.g. etch resists, electroplating resists, or permanent resists, both liquid and dry films, as photostructurable dielectricum and as solder masks for electronic circuits, as resists to manufacture colour filters (black matrix) for any type of display applications or to generate structures in the manufacturing process of plasma-display panels and electroluminescence displays, for the production of optical switches, optical lattices (interference lattice), light circuits, for producing three-dimensional articles by mass curing (UV curing in transparent moulds) or by the stereolithography technique, as is described, for example, in U.S. Pat. No. 4,575,330, to produce composite materials (for example styrenic polyesters, which may, if desired, contain glass fibres and/or other fibres and other auxiliaries) and other thick-layered compositions, for coating or sealing electronic components and chips, or as coatings for optical fibres, or for producing optical lenses, e.g. contact lenses or Fresnel lenses.

The compositions according to the invention are further suitable for the production of medical equipment, auxiliaries or implants, for the preparation of gels with thermotropic properties, as for example described in DE-19 700 064 and EP-A-678534, or also in dry paint film, as for example described in Paint & Coatings Industry, 1997(4), 72 or Plastics World 54(7), 48(5).

In coating materials, use-is frequently made of mixtures of a prepolymer with polyunsaturated monomers, which may additionally include a monounsaturated monomer as well. It is the prepolymer here which primarily dictates the properties of the coating film, and by varying it the skilled worker is able to influence the properties of the cured film. The polyunsaturated monomer functions as a crosslinking agent which renders the film insoluble. The monounsaturated monomer functions as a reactive diluent, which is used to reduce the viscosity without the need to employ a solvent.

Unsaturated polyester resins are usually used in two-component systems together with a monounsaturated monomer, preferably with styrene. For photoresists, specific one-component systems are often used, for example polymaleimides, polychalcones or polyimides, as described in DE-A-23 08 830.

The novel photocurable compositions are suitable, for example, as coating materials for substrates of all kinds to which it is intended to apply a protective layer or, by means of imagewise exposure, to generate an image, for example wood, textiles, paper, ceramics, glass, plastics such as polyesters, polyethylene terephthalate, polyolefins or cellulose acetate, especially in the form of films, and also metals or alloys thereof such as Al, Cu, brass, bronze, Ni, Fe, steel, Zn, Mg, Co, GaAs, Si or SiO₂.

Thus, the invention also pertains to a substrate onto which is a coating layer comprising iron oxide and a phthalocyanine pigment, which coating has been obtained by radiation curing of an instant composition comprising a radiation curing material and a photoinitiator.

Coatings obtained through radiation curing are generally easily identified by the presence of compounds generated from the photoinitiators upon irradiation, or reaction products thereof.

Coating of the substrates can be carried out by applying to the substrate a liquid composition, a solution or a suspension. The choice of solvents and the concentration depend principally on the type of composition and on the coating technique. The solvent should be inert, i.e. it should not undergo a chemical reaction with the components and should be able to be removed again, after coating, in the course of drying. Examples of suitable solvents are ketones, ethers and esters, such as methyl ethyl ketone, isobutyl methyl ketone, cyclopentanone, cyclohexanone, N-methylpyrrolidone, dioxane, tetrahydrofuran, 2-methoxyethanol, 2-ethoxyethanol, 1-methoxy-2-propanol, 1,2-dimethoxyethane, ethyl acetate, n-butyl acetate and ethyl 3-ethoxypropionate.

The solution is generally applied uniformly to a substrate by means of known coating techniques, for example by spin coating, dip coating, knife coating, curtain coating, brushing, spraying, especially by electrostatic spraying, and reverse-roll coating, and also by means of electrophoretic deposition. It is also possible to apply the photosensitive layer to a temporary, flexible support and then to coat the final substrate, for example a copper-clad circuit board, by transferring the layer via lamination.

The quantity applied (coat thickness) and the nature of the substrate (layer support) are dependent on the desired field of application. For the instant grey to black compositions, the range of coat thicknesses preferably comprises values from about 0.1 μm to about 2 mm, for example from 2 μm to 500 μm, most preferably from 10 μm to 300 μm. Thicker layers are possible, for example from 40 μm to 300 μm, than with prior art compositions. Of course, the skilled artisan will recognize that a compromise must be made between the hiding power, the in-depth cure properties and the energy light source to be used. For obtaining the same hiding, thick layers require the pigment concentration to be decreased when the layer thickness is increased. Nevertheless, the instant compositions advantageously show surprisingly better curing properties (such as speed, through cure or maximum achievable dry film thickness) and cured film properties (such as pendulum hardness, solvent resistance etc.), as compared with prior art compositions of same thickness, colour and hiding power.

The novel radiation-sensitive compositions further find application as negative resists, having a very high sensitivity to light and being able to be developed in an aqueous alkaline medium without swelling. They are suitable as photoresists for electronics (electroplating resist, etch resist, solder resist), the production of printing plates, such as offset printing plates or screen printing plates, for the production of printing formes for relief printing, planographic printing, rotogravure or of screen printing formes, for the production of relief copies, for example for the production of texts in braille, for the production of stamps, for use in chemical milling or as a microresist in the production of integrated circuits. The possible layer supports, and the processing conditions of the coating substrates, are just as varied.

The compositions according to the invention also find application for the production of one- or more-layered materials for the image recording ore image reproduction (copies, reprography), which may be uni- or polychromatic. Furthermore the materials are suitable for colour proofing systems. In this technology formulations containing microcapsules can be applied and for the image production the radiation curing can be followed by a thermal treatment. Such systems and technologies and their applications are for example disclosed in U.S. Pat. No. 5,376,459.

Substrates used for photographic information recordings include, for example, films of polyester, cellulose acetate or polymer-coated papers; substrates for offset printing formes are specially treated aluminium, substrates for producing printed circuits are copper-clad laminates, and substrates for producing integrated circuits are silicon wafers. The layer thicknesses for photographic materials and offset printing formes is generally from about 0.5 μm to 10 μm, while for printed circuits it is from 1.0 μm to about 100 μm.

Following the coating of the substrates, the solvent is removed, generally by drying, to leave a coat of the photoresist on the substrate.

The term “imagewise” exposure includes both, exposure through a photomask comprising a predetermined pattern, for example a slide, as well as exposure by means of a laser or light beam, which for example is moved under computer control over the surface of the coated substrate and in this way produces an image, and irradiation with computer-controlled electron beams. It is also possible to use masks made of liquid crystals that can be adressed pixel by pixel to generate digital images, as is, for example, described by A. Bertsch, J. Y. Jezequel and J. C. André in Journal of Photochemistry and Photobiology A: Chemistry 107, 275-281 (1997) and by K.-P. Nicolay in Offset Printing 1997(6), 34-37.

Following the imagewise exposure of the material and prior to development, it may be advantageous to carry out thermal treatment for a short time. In this case only the exposed sections are thermally cured. The temperatures employed are generally 50-150° C., preferably 80-130° C.; the period of thermal treatment is in general between 0.25 and 10 minutes.

Conjugated polymers, like e.g. polyanilines can be converted from a semiconductive to a conductive state by means of proton doping. The instant compositions can also be used to imagewise irradiate compositions comprising such conjugated polymers in order to form conducting structures (exposed areas) embedded in insulating material (non-exposed areas). Such materials can for example be used as wiring and connecting parts for the production of electric and electronic devices.

The photocurable composition may additionally be used in a process for producing printing plates or photoresists as is described, for example, in DE-A-40 13 358. In such a process the composition is exposed for a short time to visible light with a wavelength of at least 400 nm, without a mask, prior to, simultaneously with or following imagewise irradiation.

After the exposure and, if implemented, thermal treatment, the unexposed areas of the photosensitive coating are removed with a developer in a manner known per se.

As already mentioned, the compositions can be developed by aqueous alkalis. Particularly suitable aqueous-alkaline developer solutions are aqueous solutions of tetraalkylammonium hydroxides or of alkali metal silicates, phosphates, hydroxides and carbonates. Minor quantities of wetting agents and/or organic solvents may also be added, if desired, to these solutions. Examples of typical organic solvents, which may be added to the developer liquids in small quantities, are cyclohexanone, 2-ethoxyethanol, toluene, acetone and mixtures of such solvents.

Photocuring is of great importance for printings, since the drying time of the ink is a critical factor for the production rate of graphic products, and should be in the order of fractions of seconds. UV-curable inks are particularly important for screen printing and offset inks. As already mentioned above, the novel mixtures are highly suitable also for producing printing plates. This application uses, for example, mixtures of soluble linear polyamides or styrene/butadiene and/or styrene/isoprene rubber, polyacrylates or polymethyl methacrylates containing carboxyl groups, polyvinyl alcohols or urethane acrylates with photopolymerizable monomers, for example acrylamides and/or methacrylamides, or acrylates and/or methacrylates, and a photoinitiator. Films and plates of these systems (wet or dry) are exposed over the negative (or positive) of the printed original, and the uncured parts are subsequently washed out using an appropriate solvent or aqueos solutions.

Another field where photocuring is employed is the coating of metals, in the case, for example, of the coating of metal plates and tubes, cans or bottle caps, and the photocuring of polymer coatings, for example of floor or wall coverings based on PVC. Examples of the photocuring of paper coatings are the colourless varnishing of labels, record sleeves and book covers.

Also of interest is the use of the novel compositions for curing shaped articles made from composite compositions. The composite compound consists of a self-supporting matrix material, for example a glass fibre fabric, or alternatively, for example, plant fibres (cf. K.-P. Mieck, T. Reussmann in Kunststoffe 85, 366-370 (1995)), which is impregnated with the photocuring formulation. Shaped parts comprising composite compounds, when produced using the novel compounds, attain a high level of mechanical stability and resistance. The novel compounds can also be employed as photocuring agents in moulding, impregnating and coating compositions as are described, for example, in EP-A-007086. Examples of such compositions are gel coat resins, which are subject to stringent requirements regarding curing activity and yellowing resistance, and fibre-reinforced mouldings, for example, light diffusing panels which are planar or have lengthwise or crosswise corrugation. Techniques for producing such mouldings, such as hand lay-up, spray lay-up, centrifugal casting or filament winding, are described, for example, by P. H. Selden in “Glasfaserverstärkte Kunststoffe”, page 610, Springer Verlag Berlin-Heidelberg-New York 1967. Examples of articles which can be produced by these techniques are boats, fibre board or chipboard panels with a double-sided coating of glass fibre-reinforced plastic, pipes, containers, etc. Further examples of moulding, impregnating and coating compositions are UP resin gel coats for mouldings containing glass fibres (GRP), such as corrugated sheets and paper laminates. Paper laminates may be based on urea resins or melamine resins. Prior to production of the laminate, the gel coat is produced on a support (for example a film). The novel photocurable compositions can also be used for casting resins or for embedding articles, for example electronic components, etc. Curing usually is carried out using medium-pressure mercury lamps as are conventional in UV curing. However, there is also particular interest in less intense lamps, for example of the type TL 40W/03 or TL 40W/05. The intensity of these lamps corresponds approximately to that of sunlight. It is also possible to use direct sunlight for curing. A further advantage is that the composite composition can be removed from the light source in a partly cured, plastic state and can be shaped, with full curing taking place subsequently.

The compositions according to the invention can be used for the production of holographies, waveguides, optical switches wherein advantage is taken of the development of a difference in the index of refraction between irradiated and unirradiated areas.

The use of photocurable compositions for imaging techniques and for the optical production of information carriers is also important. In such applications, as already described above, the layer (wet or dry) applied to the support is irradiated imagewise, e.g through a photomask, with UV or visible light, and the unexposed areas of the layer are removed by treatment with a developer. Application of the photocurable layer to metal can also be carried out by electrodeposition. The exposed areas are polymeric through crosslinking and are therefore insoluble and remain on the support. Appropriate colouration produces visible images. Where the support is a metallized layer, the metal can, following exposure and development, be etched away at the unexposed areas or reinforced by electroplating. In this way it is possible to produce electronic circuits and photoresists.

Althought often referred to as “UV-region”, the photosensitivity of the novel compositions can extend in general from about 150 nm to 600 nm. Suitable radiation is present, for example, in sunlight or light from artificial light sources. Consequently, a large number of very different types of light sources are employed. Both point sources and arrays (“lamp carpets”) are suitable. Examples are carbon arc lamps, xenon arc lamps, medium-, super high-, high- and low-pressure mercury lamps, possibly with metal halide dopes (metal-halogen lamps), microwave-stimulated metal vapour lamps, excimer lamps, superactinic fluorescent tubes, fluorescent lamps, argon incandescent lamps, electronic flashlights, photographic flood lamps, light emitting diodes (LED), electron beams and X-rays. The distance between the lamp and the substrate to be exposed in accordance with the invention may vary depending on the intended application and the type and output of lamp, and may be, for example, from 2 cm to 150 cm. Laser light sources, for example excimer lasers, such as krypton F lasers for exposure at 248 nm, or F₂ excimer lasers of frequency below 200 nm are also suitable. Lasers in the visible region (or IR region in the case of borates) can also be employed. By this method it is possible to produce printed circuits in the electronics industry, lithographic offset printing plates or relief printing plates, and also photographic image recording materials.

Further embodiments are well-known in the field or can be found in conference proceedings, journals and patents, such as for example DE-33 47 374, DE-41 18 731, EP-A-706834, EP-A-970977, EP-A-971004, U.S. Pat. No. 5,824,373, U.S. Pat. No. 5,855,964, U.S. Pat. No. 5,877,231, U.S. Pat. No. 5,922,473, WO-A-97/05963, WO-A-97/27253, WO-A-98/02493 or WO-A-98/18862. Much information is publicly available from companies active in the field of radiation curing, too.

The invention therefore also provides a process for the photopolymerization of a composition comprising a monomeric, oligomeric or polymeric compound containing at least one ethylenically unsaturated double bond, a photoinitiator, iron oxide and phthalocyanine, wherein said composition is irradiated with light of the wavelength from 150 to 600 nm.

The invention additionally provides compositions for producing pigmented and nonpigmented paints and varnishes, powder coatings, printing inks, e.g. screen printing inks, inks for offset- or flexo printing, printing plates, adhesives, dental compositions, waveguides, optical switches, colour proofing systems, colour filter or colour mosaique resists, composite compositions, glass fibre cable coatings, screen printing stencils, resist materials, electroplating resists, etch resists, solder resists for encapsulating electrical and electronic components, for producing magnetic recording materials, for producing three-dimensional objects by means of stereolithography, and as image recording material, especially for holographic recordings, decolorizing materials, decolorizing materials for image recording materials, for image recording materials using microcapsules.

The invention further provides a coated substrate which is coated on at least one surface with a composition as described above, and describes a process for the photographic production of relief images, in which a coated substrate is subjected to imagewise exposure and then the unexposed portions are removed with a solvent. Imagewise exposure may be effected by irradiating through a mask or by means of a laser beam. Of particular advantage in this context is the laser beam exposure already mentioned above.

The examples which follow illustrate the invention.

### EXAMPLE 1

785.9 parts of Uvecoat® 2000 (acrylated polyester resin, UCB Chemicals, Drogenbos, Belgium), 12 parts of Resiflow® PV88 (acrylate copolymer, Worlée Chemicals GmbH, Lauenburg, Germany), 10 parts of Worlée-Add® 900 (diphenoxypropanol, Worlée Chemicals GmbH), 15 parts of Irgacure® 819 (bis(2,4,6-trimethylbenzoyl)-phenyl-phosphine oxide, Ciba Specialty Chemicals Inc., Basel, Switzerland), 15 parts of Irgacure® 2959 (1-[4-(2-hydroxyethoxy)-phenyl]-2-hydroxy-2-methyl-1-propan-1-one, Ciba Specialty Chemicals Inc.), 150 parts of Kronos® 2160 (rutile pigment, Kronos International GmbH, Leverkusen, Germany), 11.65 parts of Bayferrox® Red 180 M (Pigment Red 101, Bayer AG, Leverkusen, Germany—spherical particles of size about 0.7 μm, specific surface area 7.0 m²/g) and 0.47 parts of Irgalite® Blue PG (β-Cu phthalocyanine, Pigment Blue 15:3, Ciba Specialty Chemicals Inc.) are mixed together thoroughly using a large kitchen cutter. The composition is then extruded once only in a Prism 16 mm extruder fitted with a “super-ultra-high shear screw” at 80° C. barrel temperature and 300 rpm. The extrudates are rolled flat using a chill roll and hand crushed when cold with a rolling pin, then milled on a Retsch ZM-1™ ultracentrifugal mill at 15000 rpm using a 0.5 mm milling sieve to give a powder, which is passed through a 125 μm sieve to give the final UV-curable powder coating composition, the colour of which is neutral grey.

The UV-curable powder coating composition is applied to phosphated, cold-rolled steel panels from Advanced Coating Technologies using a Wagner Tribo-Star gun at a thickness of 70 μm. The coated panels are heated under two carbon-filament IR lamps until a surface temperature of 140° C. is reached and then cured at a band speeds of 5 m/min using an Aetek™ exposure unit fitted with two medium pressure undoped mercury lamps both at 80 W/cm.

30 minutes after cure, the panels are tested for acetone rub resistance by rubbing a 10×10×5 mm felt pad soaked in acetone over the surface of the panel for 100 double rubs. Only moderate scratching is observed visually.

A methyl ethyl ketone blister test is also carried out on the panels. A 10×10×5 mm felt pad is fully soaked in ethyl methyl ketone and placed on the paint surface, covered by, but not in contact with, a watch glass or small Petri dish. The time taken for the coating to lift the felt pad is 60 s.

The colour measurement is made on 70 μm coatings on Lineta™ contrast panels using an X-RiteT™ spectrophotometer, with 10° observer and D₆₅ illuminant, according to CIE (1964), with the differences to above-mentioned procedure that curing is accomplished at reduced speed of 3 m/min (higher UV-exposure energy) and before colour measurement, the panels are given ca. 24 hours exposure under an array of Philips® TLK 40W/05 fluorescent daylight lamps in order to photobleach any residual photoinitiator left in the coatings. The colour coordinates are: L*=70.29; C*=5.07; h=261.15, with a contrast (ΔE) of 0.09 showing an excellent hiding power (negligible effect of the panel's colour). The acetone rub rating shows only slight matting or scratches and the ethyl methyl ketone test time is 74 s.

### EXAMPLE 2

It is proceeded as in Example 1, with the difference that Irgalite® Blue GLNF (β-Cu phthalocyanine, Pigment Blue 15:4, Ciba Specialty Chemicals Inc.) is used instead of Irgalite® Blue PG. Coatings free of wrinkles and of excellent covering power are obtained. The colour cordinates are: L*=70.1; C*=4.6; h=256.2.

### EXAMPLE 3

It is proceeded as in Example 1, with the difference that Irgalite® Blue BSNF (α-Cu phthalocyanine, Pigment Blue 15:2, Ciba Specialty Chemicals Inc.) is used instead of Irgalite® Blue PG. Coatings free of wrinkles and of excellent covering power are obtained. The colour cordinates are: L*=71.6; C*=3.7; h=326.5.

### EXAMPLE 4

It is proceeded as in Example 1, with the difference that Bayferrox® Red 140 M (Pigment Red 101, Bayer AG) is used instead of Bayferrox® Red 180 M. Coatings free of wrinkles and of excellent covering power are obtained. The colour cordinates are: L*=65.8; C*=4.4; h=2.6.

### COMPARATIVE EXAMPLE 1

It is proceeded as in Example 1, with the differences that 2.50 parts of Microlen® Black B-UA (carbon black dispersion in an organic matrix, Ciba Specialty Chemicals Inc.) are used instead of 11.65 parts of Bayferrox® Red 180 M and 0.47 parts of Irgalite® Blue PG, and the amount of Uvecoat® 2000 is increased in order the total weight to be 1000 parts just as in Example 1. The acetone test leads to full destruction of the coating and the ethyl methyl ketone test a value of 39 s. The colour cordinates are: L*=69.45; C*=2.94; h=241.55.

### COMPARATIVE EXAMPLE 2

It is proceeded as in Example 1, with the differences that 0.94 parts of Special Black 250™ (Creanova AG) are used instead of 11.65 parts of Bayferrox® Red 180 M, the amount of Irgalite® Blue PG is 0.534 parts instead of 0.47 parts, and the amount of Uvecoat® 2000 is increased in order the total weight to be 1000 parts just as in Example 1. The acetone test shows heavy damage and the ethyl methyl ketone test a value of 45 s. The colour cordinates are: L*=69.05; C*=2.80; h=233.94.

### COMPARATIVE EXAMPLE 3

It is proceeded as in Example 1, with the differences that 11.2 parts of Bayferrox® Black 318 (Pigment Black 11, Bayer AG) are used instead of 11.65 parts of Bayferrox® Red 180 M and 0.47 parts of Irgalite® Blue PG, and the amount of Uvecoat® 2000 is increased in order the total weight to be 1000 parts just as in Example 1. The acetone test leads to full destruction of the coating and the ethyl methyl ketone test a value of 30 s. The colour cordinates are: L*=67.46; C*=0.75; h=241.92 (contrast=0.24).

### COMPARATIVE EXAMPLE 4

It is proceeded as in Example 1, with the differences that 9.5 parts of Cerdec® Black 10452 (Pigment Black 28, Cerdec Corp., Washington Pa., USA) are used instead of 11.65 parts of Bayferrox® Red 180 M and 0.47 parts of Irgalite® Blue PG, and the amount of Uvecoat® 2000 is increased in order the total weight to be 1000 parts just as in Example 1. The acetone test shows heavy damage and the ethyl methyl ketone test a value of 52 s. The colour cordinates are: L*=70.78; C*=3.41; h=238.79 (contrast=0.21).

From the results of Comparative Examples 14, it can be seen that the best ethyl methyl ketone resistance and acetone rub rating are consistently poorer than those of instant Example 1. These results exhibit the same trend irrespectively of the UV-exposure intensity at band speeds from 3 to 10 m/min.

1. A composition having a lightness (L*) of from 0 to 90 and a chroma (C*) of from 0 to 30, comprising a radiation curable material, iron oxide and a phthalocyanine pigment.

2. A composition according to claim 1, wherein said iron oxide is Pigment Red 101 of specific surface area from 1 to 6 m²/g and said phthalocyanine pigment is unsubstituted β copper phthalocyanine of specific surface area from 30 to 120 m²/g.

3. A composition according to claim 2, wherein said phthalocyanine pigment is Pigment Blue 15:3 or Pigment Blue 15:4.

4. A composition according to claim 1, wherein said iron oxide and said phthalocyanine pigment are comprised in a weight ratio of from 5:1 to 125:1, especially from 10:1 to 75:1, most preferred from 15:1 to 50:1, very especially from 20:1 to 30:1.

5. A composition according to claim 1, further comprising from 0.05 to 15% by weight, preferably from 0.1 to 10% by weight, most preferred from 0.2 to 5% by weight, of a photoinitiator.

6. A composition according to claim 5, wherein said photoinitiator is a mono- or bisacylphosphine oxide photoinitiator, preferably in combination with an α-hydroxy ketone or a benzyl diketal photoinitiator.

7. A composition according to claim 1, having a lightness (L*) of from 0 to 85, preferably from 0 to 80, and a chroma (C*) of from 0 to 20, preferably from 0 to 10, most preferably from 0 to 5.

8. A composition according to claim 1, further comprising a white and/or black pigment, preferably titanium dioxide, carbon black or a mixture thereof.

9. A composition according to claim 1, which is in powder form.

10. A composition comprising homogeneously mixed iron oxide and phthalocyanine pigment in a weight ratio of from 5:1 to 125:1, especially from 10:1 to 75:1, most preferred from 15:1 to 50:1, very especially from 20:1 to 30:1.

11. A composition according to claim 10, additionally comprising a carrier resin in which the iron oxide and the phthalocyanine pigment are dispersed.

12. A process for the photopolymerization of a composition comprising a monomeric, oligomeric or polymeric compound containing at least one ethylenically unsaturated double bond, a photoinitiator, iron oxide and phthalocyanine, wherein said composition is irradiated with light of the wavelength from 150 to 600 nm.

13. A process according to claim 12, wherein said composition is in powder form.

14. A process for coating a substrate with a powder composition comprising:
i) electrostatic application of the powder composition;
ii) application of heat to melt and fuse the powder; then
iii) electromagnetic irradiation of the coating.

15. A substrate onto which is a coating layer comprising iron oxide and a phthalocyanine pigment, which coating has been obtained by radiation curing of a composition according to claim 5.
